(19) United States
(12) Patent Application Publication
(10) Pub. No.: US 2010/0184325 A1
(43) Pub. Date: Jul. 22, 2010

(54) CABLE CONNECTOR ASSEMBLY WITH IMPROVED WIRE ORGANIZER

(75) Inventors: ZHU-QUAN XIAN, Shenzhen (CN); HUA-YING LIU, Shenzhen (CN); CHUNG-YEN YANG, Tu-Cheng (TW); WEN-XING TANG, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/688,927

(22) Filed: Jan. 18, 2010

(30) Foreign Application Priority Data
Jan. 18, 2009 (CN) 200910300239.X

(51) Int. Cl. H01R 33/00

(52) U.S. Cl. 439/577

(57) ABSTRACT

A cable connector assembly (100), comprising an insulative housing (1); a plurality of terminals received in the insulative housing; a plurality of wires (12) electrically connected with the terminals and extending out the insulative housing, said wires comprises divided into first group wires (121) and second group wires (122), the diameter of the second group wires thicker than the first group wires; a plurality of flat boards (2) including a number of first flat boards (21) and a number of second flat boards (22), the second flat board larger than the first flat board, the first group wires organized by first flat board and corresponding first plasters (3) enlacing the first group wires and the first flat boards, the second group wires together with the first flat boards and the first plasters organized by second flat boards and the second plasters (3).

### FIELD OF THE INVENTION

The present invention relates to a cable connector assembly, and more particularly to a cable connector assembly used in the inside of the device with organizer.

### DESCRIPTION OF RELATED ART

CN Pat. No. 2689526Y issued to William E. Spink, JR. on Feb. 18, 2004 discloses a cable connector assembly comprising an insulative housing, a plurality of terminals and a plurality of conductive wires electrical connected with the corresponding terminal. Those wires are single wires to meet the electrical performance and cost down. The number of the wire used in the CN Pat. No. 2689526Y is six, but according to the different need, the number of the wire may increase to a great deal. This cable connector assembly is used for connecting the power source and the case of the PC, whereas, the space between the power and the case of the PC is straightness for received so many messy wires, so the wire organizer become very important.

### BRIEF SUMMARY OF THE INVENTION

An object of the present invention is to provide a cable connector assembly having an improved wire organizer.

In order to achieve the above-mentioned object, a cable connector assembly comprising an insulative housing, a plurality of terminals received in the insulative housing, and a plurality of wires electrically connected with the terminals and extending out the insulative housing. The wires comprises divided into first group wires and second group wires, and the diameter of the second group wires thicker than the first group wires. A plurality of flat boards including a number of first flat boards and a number of second flat boards, the second flat board larger than the first flat board, the first group wires organized by first flat board and corresponding first plasters enlacing the first group wires and the first flat boards, the second group wires together with the first flat boards and the first plasters organized by second flat boards and the second plasters.

In order to achieve the above-mentioned object, a cable connector assembly comprising a connector; a plurality of wires which electrical connect the connector and extended out the connector, it comprises a plurality of first wires and a plurality of second wires, the diameter of first wire is different than the second wire; an organizer comprises a plurality of first flat boards, a plurality of second flat boards and some plaster, the area of the first flat board is different than the second flat board, the first wires arranged on several layer, the first flat board compart the adjacent layer of the first wires, the plaster enlace the first wires and the first board which compart the first wires, all the wires arrange on one second flat board and the plaster enlace all the wires and all the flat boards.

The foregoing has outlined rather broadly the features and technical advantages of the present invention in order that the detailed description of the invention that following may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a cable connector assembly in accordance with the present invention;

FIG. 2 is an exploded, perspective view of a cable connector assembly in accordance with the present invention;

FIG. 3 is an exploded, perspective view of a cable connector assembly in accordance with the present invention.

### DETAILED DESCRIPTION OF THE PREFERRED EMBODIMENTS

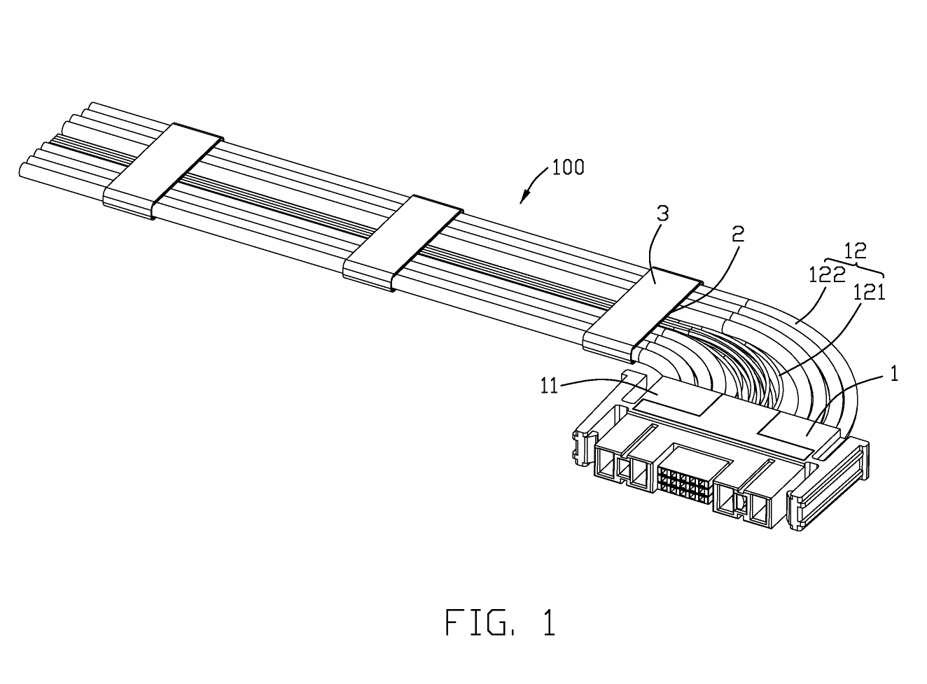

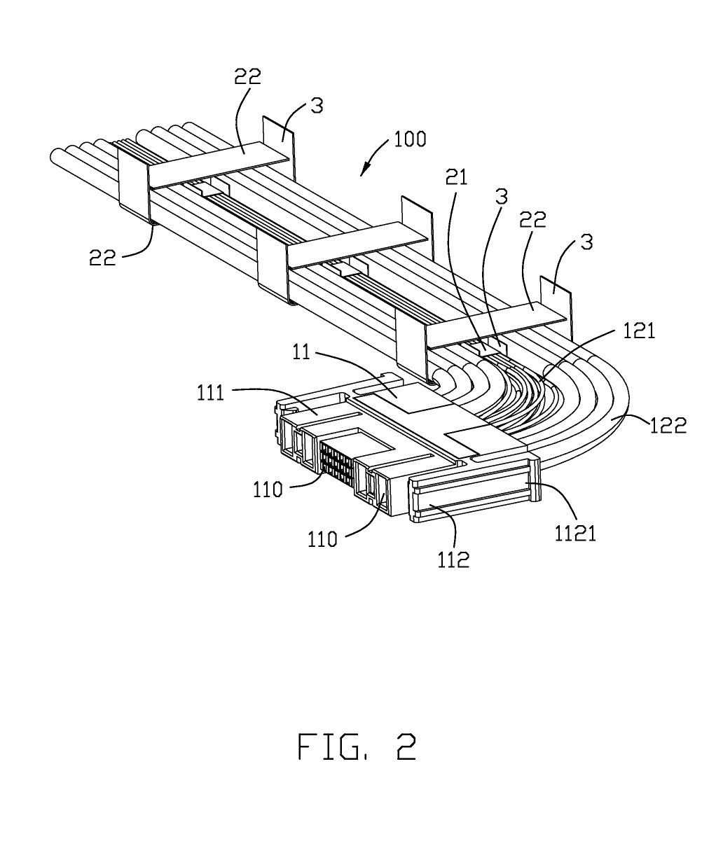

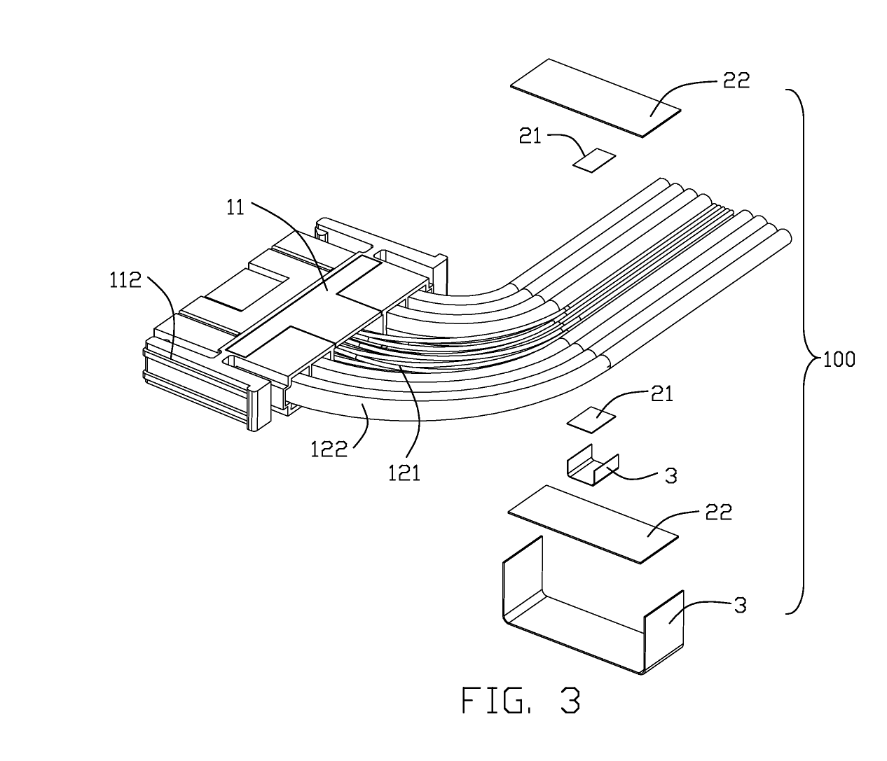

Referring to FIGS. 1-3, a cable connector assembly 100 comprises a connector 1, a plurality of flat boards 2 and a number of plasters 3.

Referring to FIGS. 1-3, the connector 1 comprises an insulative housing 11, a plurality of terminals (not shown) and a plurality of conductive wires 12. The insulative housing 11 have a plurality of passageways 110 for receiving the corresponding terminals. The wires 12 are electrically connected with the corresponding terminals and extend out the insulative housing 11. The connector 1 has a mating portion 111 for mating with the mating connector (not shown) for transmitting the signal or power. The insulative housing 11 have a pair of locking arms 112 on both side of the insulative housing 11 for locking with the mating connector. The locking arm 12 is T-shaped, via press the operating portion 1121 for release the locking status.

The wire 12 comprises a first group wires 121 and second group wires 122, the diameter of the wire 122 is larger than the wire 121. In this embodiment, the first group wire 121 comprises twelve wires, the second group wire 122 comprises ten wires.

The flat board 2 is a mylar board, it comprises the first flat board 21 for organizer the first group wire 121 and the second flat board 22 for organizer the first group wire 121 and the second group wire 122, the second flat board 22 larger than the first board 21. The plaster 3 comprise the first plaster and the second plaster, the second plaster is larger than the second plaster. The plaster 3 is an acetic acid plaster, which have high glutinosity, high strength and high temperature stability.

When assembling, arranging the first group wire 121 on two layers and letting the upper layer wire 121 pressured in the two first flat board 21 at first, and letting the lower layer wire 121 arrange the underside of the lower flat board 21, in this way the first group wire 121 parallel each other; Then, enlacing the first plaster 3 to the periphery of the first group wire 121 and two first flat board 21; Then, arranging the second group wires 122 to parallel to the first group wire 121, and pressured the first group wire 121 and the second group wire 122 in the two second flat board 22; Then, enlace the second plaster 3 to the periphery of the first group wires 121, the first flat board 21, the second group wires 122 and the two second flat boards 22. In this way, the first group wires 121 and the second group wire 122 is arranged between two second boards 22 and the second plaster 3. According to the length of the wires, one or more organizers is used for organizing all the wires.

What is claimed is:

1. A cable connector assembly, comprising:
an insulative housing;
a plurality of terminals received in the insulative housing;
a plurality of wires electrically connected with the terminals and extending out the insulative housing, said wires comprises first group wires and second group wires, the diameter of the second group wires thicker than the first group wires;
a plurality of flat boards including a number of first flat boards and a number of second flat boards, the second flat board larger than the first flat board, the first group wires organized by first flat board and corresponding first plasters enlacing the first group wires and the first flat boards, the second group wires together with the first flat boards and the first plasters organized by second flat boards and the second plasters.

2. The cable connector as claimed in claim 1, wherein the flat board is the mylar board, the plaster is the acetic acid plaster.

3. The cable connector as claimed in claim 1, wherein the first group wires are arranged in several layers, adjacent layers are compart by first flat board.

4. A cable connector assembly, comprising:
a connector;
a plurality of wires electrically connected to the connector and extended out the connector, said wires including a plurality of first wires and a plurality of second wires;
an organizer comprises a plurality of first flat boards, two second flat boards, and first plasters and a second plaster, the first wires divided into several layers, the first flat board comparting the adjacent layers of the first wires, the first plaster enlacing the first wires and the first board comparting the first wires, all the wires arrange between the two second flat board and the second plaster enlacing all the wires and all the flat boards.

5. The cable connector as claimed in claim 4, wherein a plurality of organizers are combined with the wires and disposed along the wires.

6. A cable connector assembly comprising:
an insulative housing enclosing a plurality of contacts;
a cable assembly including a plurality of wires arranged side by side along a transverse direction and electrically connected to the corresponding contacts and extending away from the housing in an extending direction perpendicular to said transverse direction under condition that some of said wires arrange in a first group are diametrically larger than others in a second group; and
a first wire retainer circumferentially and compliantly enclosing the wires in the first group at a first position of the cable assembly relative to the housing, and a second wire retainer circumferentially and compliantly enclosing the wires in the second group a second position of the cable assembly relative to the housing; wherein
said first wire retainer is larger than the second wire retainer in both transverse direction and a vertical direction perpendicular to said transverse direction and said extending direction.

7. The cable connector assembly as claimed in claim 6, wherein said first position is same with the second position so as to have said second wire retainer is enclosed in said first wire retainer.

8. The cable connector assembly as claimed in claim 7, where said cable assembly further includes a third group of wires cooperating with the first group of wires to sandwich said second group of wires therebetween in said transverse direction under condition that said third group of wires are also enclosed by said first wire retainer.

9. The cable connector assembly as claimed in claim 8, wherein said third group of wires are diametrically larger than the second group of wires.
